(19) United States
(12) Patent Application Publication
(10) Pub. No.: US 2007/0180977 A1
(43) Pub. Date: Aug. 9, 2007

(54) BREATH-CONTROLLED ACTIVATING DEVICE

(76) Inventor: James A. O'Hara, Garden City, MI (US)

Correspondence Address: Amy E. Rinaldo;KOHN & ASSOCIATES, PLLC, Suite 410, 30500 Northwestern Highway, Farmington Hills, MI, 48334, US

(21) Appl. No.: 11/670,062

(22) Filed: Feb. 1, 2007

Related U.S. Application Data
(60) Provisional application No. 60/764,858, filed on Feb. 3, 2006.

(51) Int. Cl. G10D 7/12

(52) U.S. Cl. 84/377

(57) ABSTRACT

A breath controlled actuating device for actuating another transducer device, the actuating device having a pipe including a mouthpiece and a second end, a force converter located within the second end, the force converter for converting air blown into the device into movement of a ball housed within the force converter; and a cap assembly affixed to the second end, wherein when a force is applied to the mouthpiece, the force travels through the pipe and is applied to the force converter, thereby causing the ball to impact the cap assembly and actuating the other transducer device. A method of actuating a device by blowing into the above device, flowing the blown air through the pipe and into the force converter causing the force converter to move the ball, impacting the ball against the cap assembly, sensing the impact, and transmitting the impact signal to a transducer device to be actuated, thereby actuating the transducer device.

### CROSS-REFERENCE TO RELATED APPLICATIONS

This application claims the benefit of priority under 35 U.S.C. Section 119(e) of U.S. Provisional Patent Application No. 60/764,858, filed Feb. 3, 2006, which is incorporated herein by reference.

### BACKGROUND OF THE INVENTION

1. Technical Field

The present invention relates to a breath-controlled activating device. More specifically, the present invention relates to a breath-controlled activating device for use with an electronic musical instrument.

2. Description of the Related Art

Electronic musical instruments have been developed that provide excellent simulation of a wide variety of musical instruments. The most common approach to controlling generation of such electronically generated musical tones is by way of a conventional keyboard. In addition to the typical musical voices controlled by keyboard, such as a piano, organ, harpsichord, etc., keyboard controlled electronic musical instruments can also generate a wide variety of other musical voices including stringed instruments, percussion instruments, etc. The advantages of keyboard control include familiarity of the keyboard layout, flexibility to provide different types of chords, split keyboard effects and other forms of tone control, as well as individual note generation. Other types of control systems have also been used, including drum pads for generating electronic drum sounds and other percussion sounds, and some breath controllers that simulate wind instruments. Such keyboards, drum pads and breath controllers have generally been relatively restricted in the number of tone patterns that can be generated and are typically limited to a specific instrument they are designed to emulate.

One musical instrument that has not received as significant a degree of emulation in the electronic musical instrument field as other musical instruments, is the harmonica. The harmonica has a number of advantages as an electronic musical control device, especially for novice musicians. In particular, the harmonica is a relatively simple instrument for most performers to learn to play and provides the ability to sound individual notes as well as chords. Nonetheless, the use of a suitable breath controller configured similarly to a harmonica has not been developed which can achieve the desired flexibility and compatibility with electronic musical instrument tone generation systems. However, several devices have been developed that utilize a harmonica-like breath controller. Examples of prior approaches to developing an electronic musical instrument employing a harmonica-like breath controller are disclosed in U.S. Pat. No. 4,619,175 to Matsuzaki, issued Oct. 28, 1986, and U.S. Pat. No. 4,566,363 to Arai, issued Jan. 28, 1986. Although these patents are directed to providing an electronic musical instrument control device modeled after a harmonica, they suffer from a number of disadvantages and fail to fully exploit the potentials of a breath controlled electronic musical instrument. One example of such disadvantages is that the patents do not disclose a breath controlled electronic musical instrument capable of fully simulating the effect of a harmonica in a performance environment.

More particularly, the aforementioned prior art electronic musical instruments employing harmonica type controllers require separate through holes, or apertures, to detect the sucking and blowing action of the performer of the instrument, respectively. This results in an unfamiliar breath hole layout (or spacing) for the performer as compared to a conventional harmonica. Due to the importance of slight variations of breath into the holes, this difference in the breath hole layout renders the breath control different from a harmonica. Also, the breath controllers disclosed in the aforementioned patents do not provide a system capable of rendering a live harmonica performance sound. A typical live performance of a harmonica will employ a standard hand held acoustic harmonica and a microphone held by the performer adjacent the outlet holes of the harmonica to pick up and amplify the sound. Thus, the sound that is amplified includes not only the harmonica sounds but also related sounds generated by the blowing action, as well as any related sound effects generated by the performer. In these breath controlled electronic musical instruments, the tone of the harmonica is amplified from signals in the airflow apertures which are responsive only to the air flow pressure and produce only a corresponding harmonica tone. Thus, the related sound effects provided by the performer in a live performance are omitted from the electronic musical instrument, and thus an unrealistic effect is the ultimate result.

Additionally, the above-noted prior art harmonica-like breath controllers fail to exploit the potential flexibility of an electronic musical instrument that enables the performer to control the instrument in a natural way. In particular, the '363 patent attempts to provide additional flexibility in tone generation by including a keyboard on the top of the harmonica-like breath controller unit. However, such a keyboard cannot be activated while the performer holds the harmonica-like controller unit in a natural manner adjacent his mouth. As a result, the keyboard is operated separately and independently from a harmonica-like mouth activated mode in response to a mode-setting switch. Therefore, for a given performance, little flexibility is added over a conventional acoustic harmonica despite the potential capability of an electronic musical instrument tone generation system.

U.S. Pat. No. 3,516,326 issued Jun. 23, 1970 to Hilliaret et al, discloses a harmonica in which air flow variations are sensed by piston and cylinder arrangements and motion of this mechanical transponder is directly transformed into electronic signals. The transponder is within the pipe and is necessarily operating in wet conditions under the influence of the breath and saliva of the operator. It may be difficult or impossible to prevent the condensation of moisture from the breath and/or the accumulation of saliva within the pipes. Nobel et al, in U.S. Pat. No. 3,767,833, discloses a somewhat similar system to that of Hilliaret, but Noble's device has only one pipe, different notes being achievable by keying.

For the foregoing reasons, a need presently exists for a breath controlled electronic musical instrument which is capable of triggering a device, as well as providing flexibility for additional electronic musical instrument based on sampled sounds and tones, which may be readily controlled by a performer during a performance.

### SUMMARY OF THE INVENTION

According to the present invention, there is provided a breath controlled actuating device for actuating another transducer device, the actuating device having a pipe including a mouthpiece and a second end, a force converter located within the second end, the force converter for converting air blown into the device into movement of a ball housed within the force converter; and a cap assembly affixed to the second end, wherein when a force is applied to the mouthpiece, the force travels through the pipe and is applied to the force converter, thereby causing the ball to impact the cap assembly and actuating the other transducer device. A method of actuating a device by blowing into the above device, flowing the blown air through the pipe and into the force converter causing the force converter to move the ball, impacting the ball against the cap assembly, sensing the impact, and transmitting the impact signal to a transducer device to be actuated, thereby actuating the transducer device.

### DESCRIPTION OF THE DRAWINGS

Other advantages of the present invention are readily appreciated as the same becomes better understood by reference to the following detailed description, when considered in connection with the accompanying drawings wherein:

FIG. 1 is a side view of the device of the present invention;

FIG. 2 is a side view of the device of the present invention with dimensions;

FIG. 3 is a side view of an alternative embodiment of the device of the present invention;

FIG. 4 is a side view of an alternative embodiment of the device of the present invention;

FIGS. 5A through 5D are photographs of alternative embodiments of the device of the present invention; and

FIG. 6 is a side view of an alternative embodiment of the device of the present invention.

### DESCRIPTION OF THE INVENTION

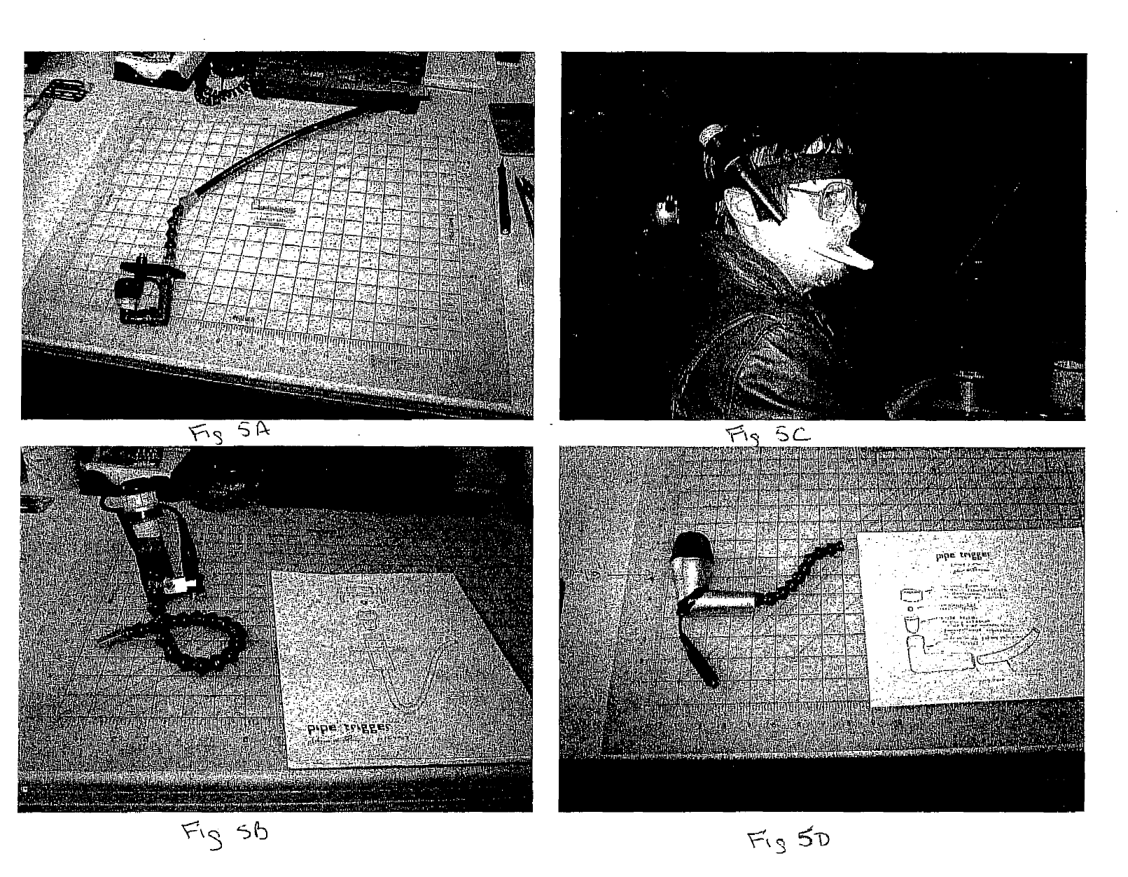

Generally, the present invention provides a breath-controlled activating device, generally shown at 10 in the figures, which can be operated by the user's mouth. The breath-controlled activating device can be used to produce signals that can be used to operate existing electronic musical instruments. The device 10 is also suitable for producing signals to correspond with keys on a typewriter, a computer keyboard, or that correlate to movements of a computer mouse. The breath-controlled activating device can be sized such that it can be placed in another part, such as a microphone or on a headband (see FIGS. 5A and 5B) for easier use.

The term “breath-controlled activating device” as used herein is intended to include, but is not limited to, a mechanism that creates a signal that in turn activates a device. The breath-controlled activating device of the present invention is a breath-controlled activating device that is capable of being actuated controlled by the user's mouth, more specifically the user's breath.

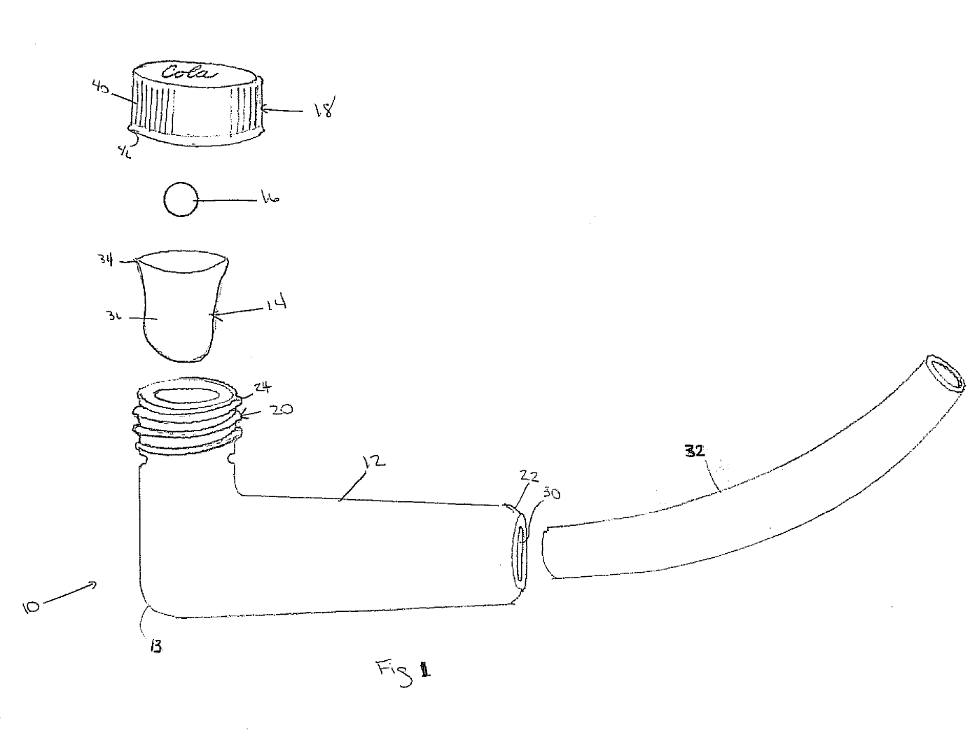

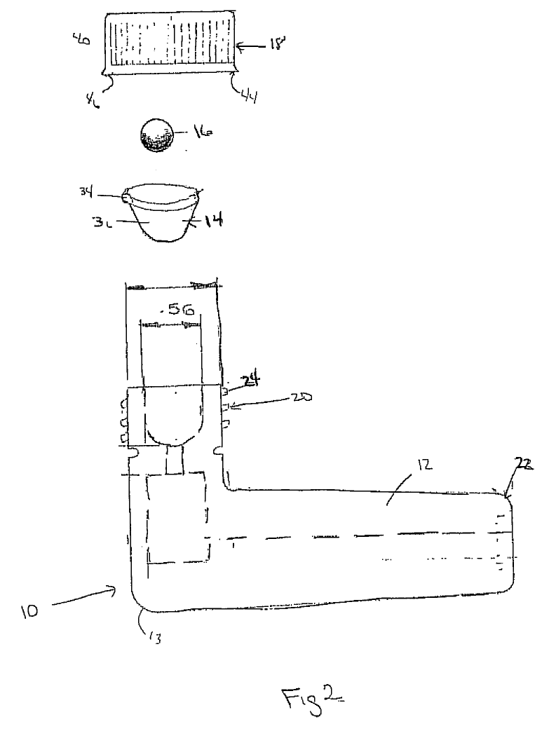

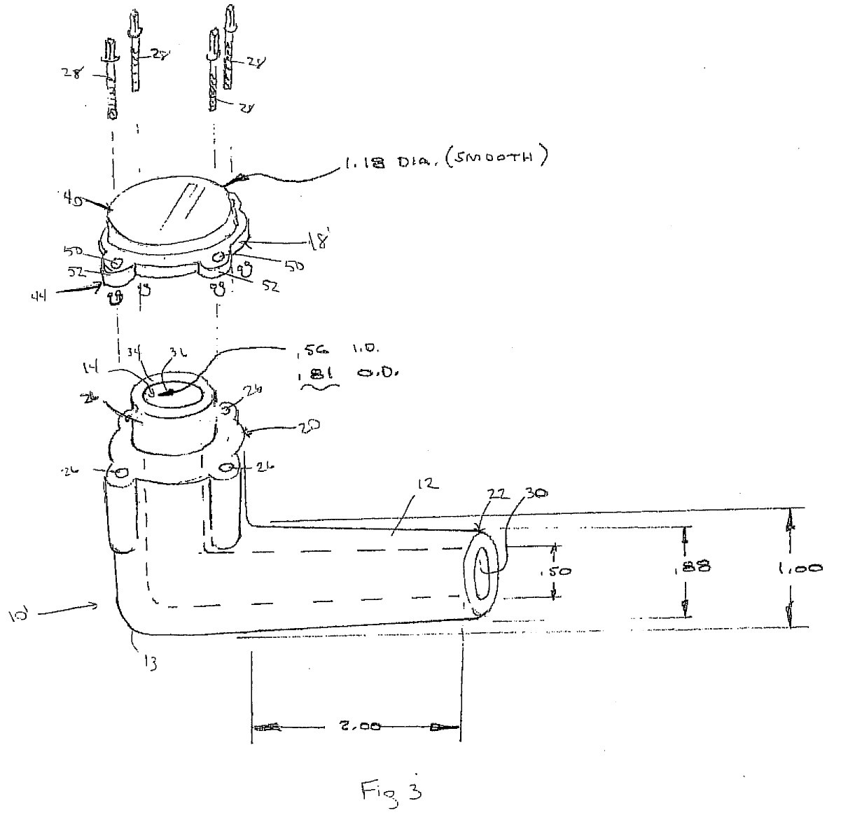

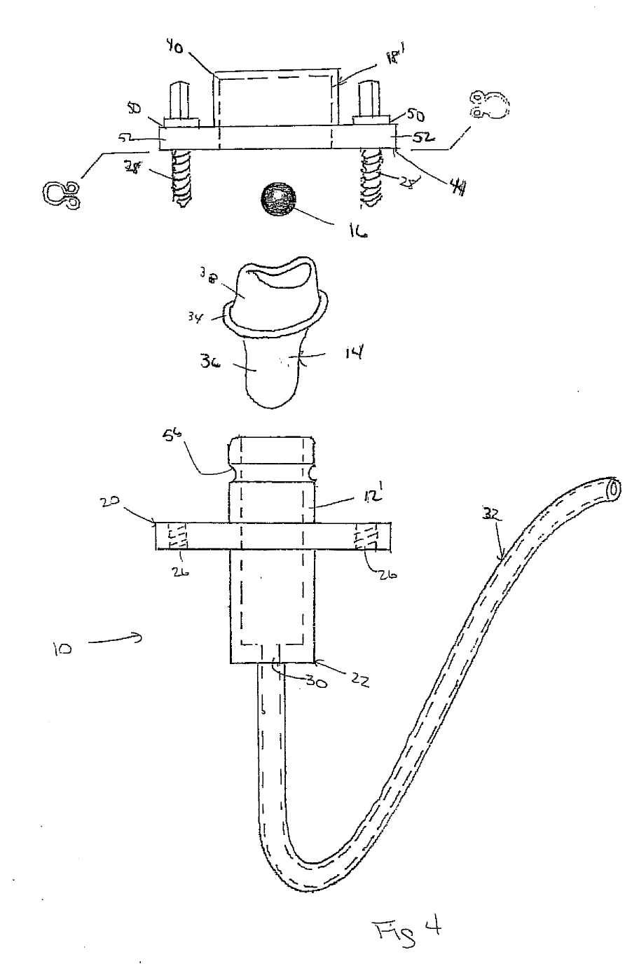

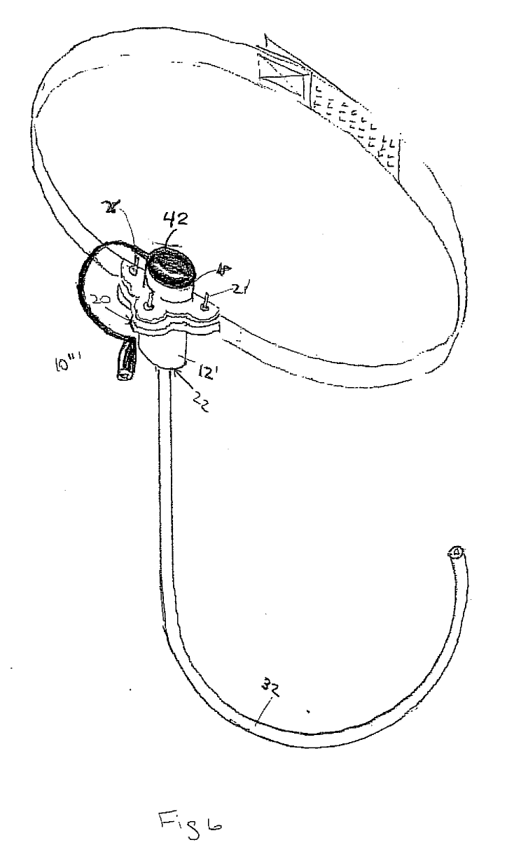

The device 10 includes a pipe 12, force converter 14, ball 16, and cap assembly 18. The pipe 12 is a hollow tube as shown in the Figures. The pipe 12′ can be a straight tube as shown in FIGS. 4-6 or the pipe 12 can be include a bend 13 as shown in FIGS. 1-3. When the pipe is bent, the bend 13 is at least 30 degrees. In the preferred embodiment, as shown in FIGS. 1-3, the bend 13 is 90 degrees. The bend 13 is designed to keep the device 10 upright. However, as shown in FIGS. 4-6, the device 10 can be designed so that a bend in the pipe 12 is not necessary for proper use.

The pipe 12 is made of a resilient material such as plastic. Examples of such materials are well known to those of skill in the art. The pipe 12 is sized sufficiently to enable actuation of an electronic musical instrument or other device to which the device 10 is attached, but the diameter of the device 10 is also small enough to fit inside the user's mouth. For example, the pipe 12 can have a ½ inch or ⅜ inch diameter. Alternatively, a variety of diameters can be used without departing from the spirit of the present invention.

The pipe 12 includes a cap affixing device 20 and a mouthpiece 22. The cap affixing device 20 is located on an end of the pipe 12 opposite the mouthpiece 22. The cap affixing device 20 can be any device that is capable of engaging and maintaining the cap assembly 18 in place. Examples of such devices include, but are not limited to, threads 24, screw holes 26 (for maintaining screws 28 therein), or a snap fit lock (not shown). The snap fit lock includes a groove in the cap affixing device 20 for receiving a lip on the cap assembly 18, thereby maintaining the cap assembly 18 in place. Other affixing devices known to those of skill in the art can also be used without departing from the spirit of the present invention.

The mouthpiece 22 is sized to fit within the user's mouth. The mouthpiece 22 can be an opening 30 on the end of the pipe 12. Preferably, the mouthpiece 22 is formed as a single unit with the pipe 12 and thus is made of the same material as the pipe 12. Alternatively, the mouthpiece 22 can be a separate piece of material that can be affixed either to, about, or within the pipe 12. In such case, the mouthpiece 22 can either be made of the same material as the pipe 12 or another material capable of being inserted into the user's mouth. Additionally, the mouthpiece 22 can include an extender piece 32 that enables the user to be further away from the mouthpiece 22. The extender piece 32 is preferably a piece of plastic or vinyl tubing. However, other pliable and bendable materials that are known to those of skill in the art can also be used without departing from the spirit of the present invention. Further, the extender piece 32 can be encased in a pliable material that can retain a position, as shown in FIGS. 5A-5D. The material enables the extender piece 32 to be shaped into a specific configuration so that the extender piece 32 maintains that position.

The ball 16 is a round hard ball that does not deform after repeatedly impacting the cap assembly 18. The ball 16 can be formed of a metal, for example steel, ceramic material, or glass material. Examples of such balls include, but are not limited to, ball bearings and other metal balls known to those of skill in the art.

The force converter 14 of the present invention is held in place within of the pipe 12 at the cap affixing device 20 end of the pipe 12. Since the pipe 12 is hollow, the force converter 14 is located at the end of the pipe 12 containing the cap affixing device 20. The force converter 14 is sized to fit within the pipe 12. The force converter 14 can be affixed to the pipe 12. Examples of affixing devices include, but are not limited to, rubber collars, rubber bands, glue, and other affixing devices known to those of skill in the art for affixing one object to another. Alternatively, the converter 14 can be crush locked in place between the cap affixing device 20 and the cap assembly 18. More specifically, the force converter 14 is a generally cup shaped device 36 with a lip 34. The lip 34 is the portion of the converter 14 that is affixed to the pipe 12. The lip 34 enables the converter 14 to be affixed without adversely affecting the functionality of the converter 14. In other words, while the lip 34 can be maintained in place, the lip 34 does not limit the ability for the cup 36 to deform. The lip 34 is a ring of rolled material the rests in a slot 56 on the outside of the pipe 12. The cup 36 is of sufficient strength to both hold the ball 16 when the ball 16 is in a resting position and, when force is applied to the cup 36, from the breath of the user, move so as to cause the ball 16 to come into contact with the cap assembly 18 and then catch the call 16 when the ball lands. The converter 14 can also include walls 38 for ensuring that the ball 16 only impacts the cap assembly 18 at a single location. The walls 38 are preferably formed as a single unit with the converter 14. The converter 14 is preferably made of a deformable, resilient material. One example of such a material is latex; however, other materials having these characteristics can also be used without departing from the spirit of the present invention.

The cap assembly 18 includes a cap 40, an impact sensor 42, and a mating device 44 for matingly engaging the cap affixing device 20 and thus maintaining the cap assembly 18 in place. The cap assembly 18 can also include air release holes (not shown) in the cap 40. The air release holes allow air to escape from the cap assembly 18. The mating device 44 can be any device capable of engaging the cap affixing device 20. Examples of such mating devices can include, but are not limited to, threads 46, screw assemblies 48, and a lip. The cap threads 46 matingly engage the threads of the cap affixing device threads 24. This allows the cap assembly's position to be adjusted by altering the degree of engagement of the threads 24,46. Alternatively, a screw assembly 48 can be used to affix the cap assembly 18. The screw assembly 48 includes screws 28 and apertures 50 on the cap 40 through which the screws 28 traverse in order to secure the cap assembly 18 to the cap affixing device 20. The screws 28 traverse through the cap assembly apertures 50 and into the screw holes 26 of the cap affixing device 20. The screw apertures 50 can either be located in the cap 40 itself or in arms 52 extending from the cap 40.

The cap 40 is formed of a rigid material. Preferably, the rigid material is a plastic, but other materials known to those of skill in the art can also be used without departing from the spirit of the present invention. The cap 40 also includes a transducer impact sensor 42. The impact sensor 42 can be located within or on an exterior surface of the cap assembly 18. The impact sensor 42 can be any sensor known to those of skill in the art that is able to detect an impact and that is small enough to fit within the device of the present invention. The impact sensor 42 is in communication with an electronic musical instrument, or other device, such that when the impact sensor 42 senses an impact the sensor 42 causes the instrument to make a noise, or in the instance of a different device, causes the device to function in a predetermined manner. The impact sensor 42 can either be hard wired to the electronic musical instrument or can be attached via a wireless communication device. Examples of both connections are well known to those of skill in the art.

Generally, the device is assembled as follows. A cap is affixed on top of the vertical portion of the junction. The cap assembly 18 covers the force converter 14 and ball 16 to maintain the entire mechanism in place. An impact sensor 42, preferably a velocity sensing transducer, can be affixed on top of the cap assembly 18. The cap assembly 18 can then be affixed the pipe 12 to create the device 10 of the present invention.

The device can be used to trigger any device that can be operated via a trigger or actuator. Examples of such triggerable devices include, but are not limited to an electronic drum module, a musical instrument digital interface (MIDI), a video game, medical devices, and other devices.

In use, the device 10 functions such that air is blown into the mouthpiece 22 of the device 10. The air flows through the pipe 12 and the force of the air pushes the converter 14 and thereby moves/forces the ball 16 upward against the cap assembly 18. The force that the ball 16 impacts the cap assembly 18 is transmitted to the sensor 42 on the cap assembly 18 and affects the musical instrument, or other device, that is being used. For example it can affect tempo of the musical instrument if the device is a musical device or it can affect how far something progresses.

Throughout this application, author and year, and patents, by number, reference various publications, including United States patents. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the described invention, the invention may be practiced otherwise than as specifically described.

What is claimed is:

1. A breath controlled actuating device for actuating another device, said actuating device comprising:
a pipe having a mouthpiece and a second end;
force converting means located within said second end, said force converting means converting air blown into the device into movement of a ball housed within said force converting means; and
a cap assembly affixed to said second end, wherein when force is applied to said mouthpiece, the force travels through said pipe and is applied to said force converting means, thereby causing said ball to impact said cap assembly and actuating the other device.

2. The breath controlled actuating device according to claim 1, wherein said mouthpiece is a single unit with said pipe.

3. The breath controlled actuating device according to claim 1, wherein said mouthpiece is a piece separate from said pipe.

4. The breath controlled actuating device according to claim 1, wherein said force converting means is a cup including a lip.

5. The breath controlled actuating device according to claim 4, wherein said cup is formed of a resilient, deformable material.

6. The breath controlled actuating device according to claim 5, wherein said material is latex.

7. The breath controlled actuating device according to claim 1, wherein said ball is formed of metal.

8. The breath controlled actuating device according to claim 7, wherein said ball is a ball bearing.

9. The breath controlled actuating device according to claim 1, further including cap affixing means on said second end of said pipe for affixing said cap assembly to said pipe.

10. The breath controlled actuating device according to claim 9, wherein said cap affixing means is selected from the group consisting essentially of threads, a groove, and screw holes.

11. The breath controlled actuating device according to claim 10, wherein said cap assembly comprises:
a cap;
impact sensing means for sensing an impact on said cap; and
mating means for engaging said cap assembly with said pipe.

12. The breath controlled actuating device according to claim 11, wherein said mating means is selected from the group consisting essentially of threads, a lip, and screws.

13. The breath controlled actuating device according to claim 1, further including an extender piece affixed to said mouthpiece.

14. The breath controlled actuating device according to claim 13, wherein said extender piece is formed of a bendable material.

15. A method of actuating a device by:
blowing into the device of claim 1;
flowing the blown air through the pipe and into the force converter causing the force converter to move the ball;
impacting the ball against the cap assembly;
sensing the impact; and
transmitting the impact signal to a device to be actuated, thereby actuating the device.
